(19) United States
(12) Patent Application Publication
(10) Pub. No.: US 2022/0271971 A1
(43) Pub. Date: Aug. 25, 2022

(54) METHOD FOR OPERATING A VEHICLE ELECTRICAL SYSTEM, VEHICLE ELECTRICAL SYSTEM, AND CONTROL UNIT

(71) Applicant: Robert Bosch GmbH, Stuttgart (DE)

(72) Inventors: Josef Newald, Stuttgart (DE); Lambros Dalakuras, Leonberg (DE); Liem Dang, Ludwigsburg (DE); Manuel Warwel, Tamm (DE)

(21) Appl. No.: 17/677,033

(22) Filed: Feb. 22, 2022

(30) Foreign Application Priority Data
Feb. 24, 2021 (DE) 10 2021 104 420.0

(51) Int. Cl. H04L 12/40; G07C 5/00

(52) U.S. Cl. CPC H04L 12/40039; G07C 5/008; H04L 2012/40273; H04L 2012/40215

(57) ABSTRACT

A method for operating a vehicle electrical system of a vehicle, including a vehicle central computer, multiple intermediate control units, and at least one execution unit for each intermediate control unit. The vehicle electrical system is designed in an architecture in which the vehicle central computer is associated with a computational layer, intermediate control units are associated with an intermediate layer, and execution units are associated with an execution layer. Intermediate control units are each communicatively connected to a vehicle central computer via a first communication system, and each of the execution units is communicatively connected, directly or indirectly, to the intermediate control unit associated with it via a second communication system. A communication between an execution unit and a vehicle central computer takes place via an intermediate control unit. A communication between two multiple intermediate control units takes place solely via the computational layer.

### FIELD

The present invention relates to a method for operating a vehicle electrical system, a vehicle electrical system, a control unit, and a method for configuring a vehicle electrical system in a vehicle.

### BACKGROUND INFORMATION

In modern vehicles, there are various functions that are implemented by individual control units, and sensors and actuators connected thereto. Control units may in turn be connected to one another in a data-transmitting or communicative manner in order to exchange data or information. The entirety of control units, sensors, and actuators as well as possibly other components such as communication links in particular is also referred to as the vehicle electrical system or vehicle data network, and its design and configuration are also referred to as E/E architecture.

### SUMMARY

According to the present invention, a method for operating a vehicle electrical system, a vehicle electrical system, a control unit, and a method for configuring a vehicle electrical system in a vehicle, having the features of the independent claims, are provided. Advantageous embodiments of the present invention are disclosed herein.

The present invention relates to a vehicle electrical system or the E/E architecture in a vehicle, and in particular to the communication between various units in this vehicle electrical system. Driven by cost optimization, increasing complexity of the electronics in the vehicle, and new options due to technical progress, efforts are being made, in particular by vehicle manufacturers, to optimize the E/E architecture. In order on the one hand to save costs by simplifying the wiring harness, and on the other hand to increase the flexibility and scalability by concentrating or centralizing software on so-called vehicle central computers, the use of a so-called zonal E/E architecture or zone architecture comes into consideration. In zonal E/E architecture, for example sensors, actuators, “intelligent” mechatronics or mechatronic units (so-called smart components, which are understood herein to mean mechanical units having their own computational logic system or controller, for example a radiator mechatronic system made up of a fan motor, fan output stage, and fan microcontroller, or for example the mechatronics of a transmission that controls shifting operations) and (smart) electronic control units (ECUs), i.e., control units in the conventional sense, and other mechatronic units, are connected, corresponding to their geometric position in the vehicle, to one or more vehicle central computers via so-called zone control units. The zone control units function in particular as energy and data distributors, the actual logic or function being executed or computed, at least to the extent possible, on the vehicle central computer.

The centralization of the software (with logic and function) is typically accompanied by the use of fairly powerful processing units on the vehicle central computer; the current, commonly used microcontroller (pC)-based systems are expanded in this device class with microprocessors (pP). The operating systems (POSIX-based operating systems, for example) running thereon enable a so-called service-oriented architecture (SOA) that allows efficient and rapid development of functions.

With the introduction of this zone architecture, the star-shaped cable network used thus far may be broken up and significantly simplified. As a result, much shorter lines are made possible overall, which reduces the complexity in the main wiring harness of the vehicle. Due to shifting the high-level software (having various functionalities, for example for the driver) into the vehicle central computer, the computation effort is concentrated in the vehicle central computer. The concentration is particularly facilitated by the communication concept presented below.

As mentioned, the vehicle electrical system or the E/E architecture of a vehicle, as used within the scope of the present invention, is based on an architecture such as zone architecture. This zone architecture has three layers: a computational layer, a zonal layer, and an execution or embedded layer. The vehicle central computer is provided in the computational layer. It is also possible to use multiple such vehicle central computers, which are then correspondingly associated with all of the computational layers. Typically and also preferably, the vehicle central computer is connected (in particular wirelessly) to a vehicle-external or vehicle-remote processing unit such as a remote computer system or a server (“cloud”), via which various functions or services or also software updates may be provided. With multiple vehicle central computers, connecting one of them to the vehicle-remote processing unit may be sufficient. This vehicle-remote processing unit may then likewise be associated with the computational layer.

Zone control units (in the generic sense) are provided in the zonal layer, typically multiple zone control units being present even if the zone architecture is basically usable for only one zone control unit. Execution units (in the generic sense) are provided in the execution layer, typically multiple execution units being present for each zone control unit, even if the zone architecture is basically usable for only one execution unit overall, or one execution unit for each zone control unit.

The zone control units, which may be relatively simple computer systems or processing units as explained in greater detail below, are used in particular for the geometric or spatial distribution in the vehicle. For example, four zone control units may be provided, one each for the front, rear, left, and right sides of the vehicle (in this regard, also see the figures together with the description of the figures). Execution units are understood in particular to mean sensors, actuators, so-called smart components (intelligent mechatronics) or (smart) electronic control units (ECUs), i.e., conventional control units, and other mechatronic units that are situated on the lowest layer and responsible for (directly) carrying out actions or measurements. Due to the association of the execution units with one zone control unit in each case, the individual execution units may also be correspondingly associated with one zone such as “front” or “rear.” For example, all control units situated in the engine compartment may be associated with the “front” zone.

The zone control units are in each case communicatively connected to the vehicle central computer (or the computational layer) with the aid of a first communication system. For example, Ethernet or some other broadband communication system comes into consideration here as the first communication system. In the case of multiple vehicle central computers, each zone control unit may be connected to (only) one of these vehicle central computers. Each execution unit is communicatively connected, directly or indirectly, to the zone control unit associated with it via a second communication system, such as a communication bus. For example, a CAN bus or LIN bus comes into consideration here as the second communication system or communication bus. Various execution units may be connected to the same zone control unit, or also possibly via various communication buses. Individual execution units may be directly connected to the associated zone control unit, this applying in particular for control units or smart or intelligent sensors and actuators. However, an execution unit may likewise be indirectly connected to the zone control unit, in that case via such a control unit, for example. This applies in particular for simple sensors and actuators. For all communication systems, a communicative connection is understood in particular to mean that data or information may be exchanged, in particular digitally (but also possibly in an analog manner for simple sensors).

In addition to this zone architecture and the mentioned communication links, a particular communication is also provided that is used during operation of such a vehicle electrical system, or for which purpose such a vehicle electrical system together with its units is configured.

As will become apparent from the following discussion, not only does the present invention function for such a zone architecture, but in addition an architecture having the mentioned three layers is sufficient. A (geometric) division by zones is advantageous, but not absolutely necessary. In this sense, instead of zone control units, reference is also made below to intermediate control units (which are then associated with an intermediate layer). Likewise, the architecture that is used accordingly does not necessarily have to be a zone architecture.

Within the meaning of the present invention, a vehicle electrical system includes at least the following elements mentioned with regard to the zone architecture: vehicle central computers, zone or intermediate control units, execution units (in particular at least one in each case), and the respective communication systems, in particular provided that they are present in a vehicle, for example.

In accordance with an example embodiment of the present invention, a communication between an execution unit and a vehicle central computer (always) takes place via an intermediate control unit. This correspondingly applies for any communication between the execution layer and the computational layer. A communication between two intermediate control units, i.e., a communication that runs, for example, from an execution unit via the associated intermediate control unit, and via a different intermediate control unit to a different execution unit, in turn takes place solely via the computational layer (i.e., the vehicle central computer; for multiple vehicle central computers, communication from one central computer to another may also be necessary). Thus, the intermediate control units do not communicate directly with one another, and in addition no corresponding (direct) communication link is provided.

In the communication between the execution unit and the vehicle central computer, the intermediate control unit preferably re-outputs incoming data or information unchanged within the scope of the communication. This applies for all intermediate control units, whose behavior is thus neutral or transparent. Data are not converted or modified, but instead, for example tunneling of CAN or LIN, for example, via Ethernet, for example, takes place. The tunneling may take place, for example, according to an AVTP control format (ACF) according to IEEE 1722-2016 AVB Transport Protocol (AVBTP). For example, standard packets of some other transmission format (for example, CAN, LIN; FlexRay, MOST etc.) may be packed and transmitted in Ethernet. In one direction, the intermediate control unit removes the standard packets from the Ethernet packets and outputs them on the corresponding bus. Correspondingly, for the other direction, the intermediate control unit receives the standard packets and packs them into the Ethernet packets. Thus, it is understood that, although the intermediate control unit must “bridge” the data between possibly different communication systems or communication buses, the content remains unchanged. Thus, no computations or the like are carried out.

This design having the architecture and the proposed communication concept in accordance with the present invention has several advantages. For example, reuse of existing systems and control units in the execution layer, which in terms of their number and characteristics may be connected very easily to the zone, for example (similar to “plug and play”), is made possible. No particular adaptation on the intermediate or zone control unit is necessary here, since the data are merely looped through.

In addition, reuse of a certain function with different vehicle hardware is made possible. The vehicle central computer in particular takes responsibility for the function, whereas the specific hardware on the execution layer is of secondary importance. Thus, for example, a certain sensor may easily be replaced by a sensor from some other manufacturer.

Due to the abstraction between the execution layer and the computational layer, in the ideal case new vehicle functions are possible just by updating software functions on the vehicle central computers, without the need to update the software of the intermediate control units or downstream components (in particular in the execution layer); however, these may still be updated, as explained in greater detail below.

Since the intermediate control units do not communicate with one another and are thus decoupled from one another, a scaling over vehicle segments may be implemented in a simplified manner using a different number of intermediate control units, in particular zone control units. For example, a further intermediate control unit may be supplemented with downstream execution units without this affecting the other intermediate control units or their downstream execution units. In contrast, the vehicle central computer is appropriately designed for additional units and functions.

In addition, stable interfaces between the vehicle central computer and an intermediate control unit are thus made possible, in particular signal-based as well as service-based interfaces. The scaling is determined only by the required bandwidth (for the communication via the interface), and not by individual communication technologies (for communication buses, for example). Whereas via a signal-based interface, data or information are/is provided only if present, via a service-based interface (or in a “service-oriented architecture”) the data or information are/is provided as services; i.e., each processing unit (in the present case, each zone control unit) may subscribe to the required services, and the data are sent to the processing unit.

Furthermore, a service-oriented architecture on vehicle central computers is assisted by the abstraction of the hardware in the lower layers and underlying layers. The vehicle central computers scale only with regard to memory and performance (computing capacity) and thus, the accompanying circuit board surface area or the use of microcontrollers (pC) or microprocessors (pP).

In accordance with an example embodiment of the present invention, software updates, i.e., updates of applications or functions, take place, as mentioned above, predominantly on or via the computational layer, since all software functions are concentrated there. For the case that the execution layer or an execution unit is to receive an update, the intermediate control units may function as buffers; i.e., the new (embedded) software version (i.e., updated program data) is loaded onto the intermediate control unit via the broadband connection between the vehicle central computer and the intermediate control unit, and from there is transferred to the embedded control unit or the execution unit via a possibly slower bus (i.e., having a lower data transfer rate). The intermediate control unit is thus used as an intelligent gateway or subgateway with the option for parallelization (new software that is intended for downstream execution units in each case may be loaded onto each intermediate control unit). This also allows more rapid input of the new software onto multiple target control units (in the execution layer), which have a slow connection. This procedure may in particular also reduce flash times during vehicle production or subsequently.

In addition to a method for operating such a vehicle electrical system in a vehicle, the present invention further relates to such a vehicle electrical system, a control unit for use as an intermediate control unit in such a vehicle electrical system, and a method for configuring such a vehicle electrical system in a vehicle. For further embodiments and advantages of the vehicle electrical system, control unit, and method for configuration, to avoid repetitions reference is made to the above statements, which correspondingly apply here.

Further advantages and embodiments of the present invention result from the description herein and the figures.

The present invention is schematically illustrated in the figures based on one exemplary embodiment, and is described below with reference to the figures.

### BRIEF DESCRIPTION OF THE DRAWINGS

FIG. 1 schematically shows a vehicle electrical system according to the present invention in one preferred example embodiment of the present invention in a vehicle.

FIG. 2 schematically shows a zone architecture of a vehicle electrical system for explaining the present invention.

### DETAILED DESCRIPTION OF EXAMPLE EMBODIMENTS

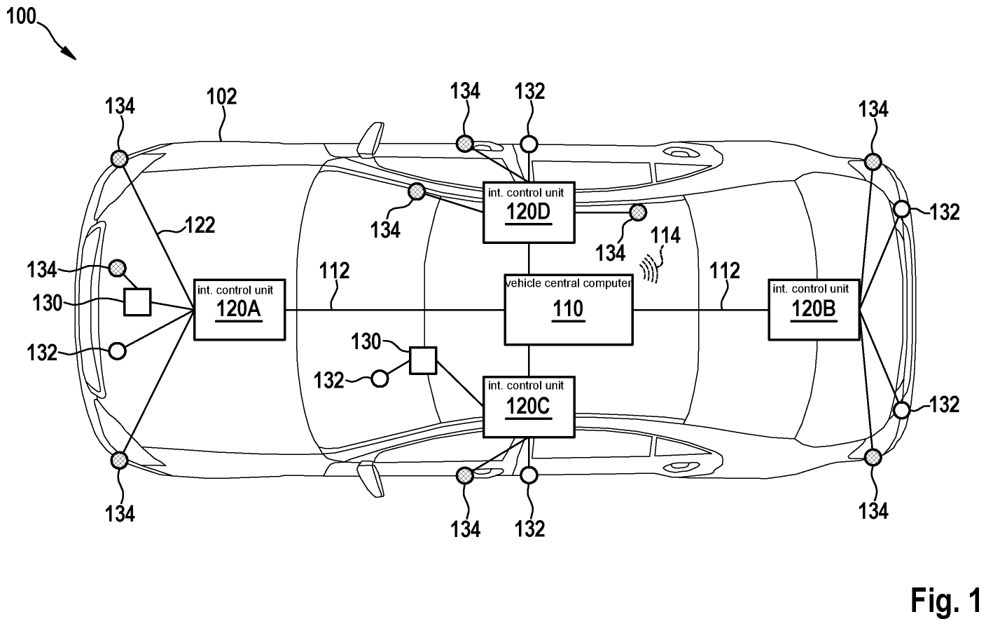

FIG. 1 schematically illustrates a vehicle electrical system 100 according to the present invention in one preferred embodiment in a vehicle 102, on the basis of which the E/E architecture and the distribution of the individual units or components of the vehicle electrical system are to be explained. Vehicle electrical system 100 includes by way of example a vehicle central computer 110, four intermediate control units 120A, 120B, 120C, 120D that are designed (or used) as zone control units, and multiple execution units, which in the present case include control units 120, intelligent mechatronic units 132, and actuators and sensors 134 (a distinction is not made here between actuators and sensors).

Zone control units 120A, 120B, 120C, 120D are respectively associated with a “front,” “rear,” “left,” and “right” zone by way of example, and in each case are communicatively connected to vehicle central computer 110 via a first communication system 112, for example Ethernet, which allows a communication of each of the zone control units with vehicle central computer 110. In addition, vehicle central computer 110 includes a wireless communication link 114 (or a corresponding communication module) to allow communication with a vehicle-remote processing unit (“cloud”), for example, as explained in greater detail below.

Execution units 130, 132, 134 are each associated with one of the zone control units, and are communicatively connected, directly or indirectly, to the zone control unit in question via a second communication link 122 such as a CAN bus or LIN bus. For example, control unit 130 associated with control unit 120A is directly connected to the zone control unit, whereas one of sensors/actuators 134 is indirectly connected, namely, via control unit 130; this sensor/actuator 134 is in particular directly connected to control unit 130. Other sensors/actuators 134 are, for example, also directly connected to the zone control unit, and the same applies for intelligent mechatronic units 132.

Second communication systems 112 for connecting the execution units to the zone control units or optionally to one another do not necessarily all have to be identical; a difference is possible, depending on the type of execution unit. Thus, simpler sensors are connected only via LIN, for example, and slightly more complex control units are connected via CAN, for example. However, the zone control units have corresponding interfaces.

The specific type or functionality of execution units 130, 132, 134 is not important for the present invention; for example, execution units 130, 132, 134, which are associated with zone control unit 120A and thus with the “front” zone, include, for example, lights or actuators for windshield wipers or the like. The same applies for zone control unit 120B or the “rear” zone. The execution units associated with zone control units 120C, 120D or the respective “left” and “right” zones may be, for example, buttons and actuators for window lifts. At this point it is noted once more that this vehicle electrical system is strictly an example intended for explanation of the present invention.

However, it is clear from vehicle electrical system 100 shown that a targeted association or division of the individual execution units according to geometric zones by the zone control units is possible for only one vehicle central computer (or possibly a few vehicle central computers), as the result of which the entire (cumulative) length of cables for the vehicle electrical system may sometimes be reduced significantly compared to conventional E/E architecture.

At this point it is noted that this pertains in particular to the communication systems or communication media. It is understood that an energy or power supply, not further discussed here, is also necessary for the individual units.

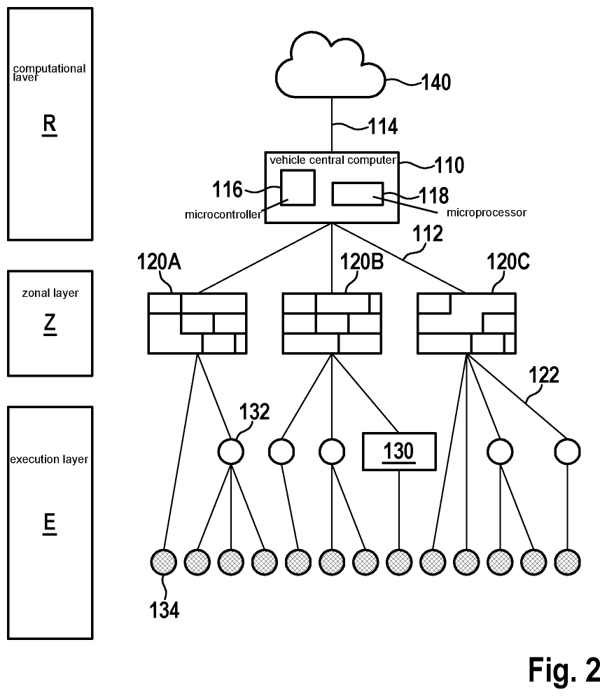

FIG. 2 schematically illustrates a zone architecture of a vehicle electrical system for explaining the present invention. The vehicle electrical system shown here is comparable to vehicle electrical system 100 from FIG. 1, but with a slightly changed number of individual units; however, the designations correspond to those from FIG. 1. Thus, for example, only the three zone control units 120A, 120B, 120C with which execution units are associated in each case, and whose number possibly differs from that from FIG. 1, are shown. However, this has no effect on the functional principle of the present invention.

As mentioned above, within the scope of the present invention a zone architecture having three layers, with which the individual units are associated, is used. Vehicle central computer 110, shown here with a microcontroller 116 and a microprocessor 118 by way of example, is associated with computational layer R. Likewise shown is a vehicle-remote processing unit 140 (which is, for example, a central server or high-performance computer that is situated remotely from the vehicle and that provides memory and computing power), to which the vehicle central computer is connected via wireless communication link 114. Vehicle-remote processing unit 140 is likewise associated with computational layer R.

Zone control units 120A, 120B, 120C are associated with zonal layer Z, and execution units 130, 132, 134 are associated with execution or embedded layer E. Within execution layer E, control units 130 and intelligent mechatronic units 132 are situated in an intermediate stage above sensors/actuators 134, which, however, has no effect on the functional principle of the present invention.

The communication systems and the communicative connection, explained above with reference to FIG. 1, result in the communication concept that a communication between an execution unit (in execution layer E) and the vehicle central computer (in computational layer R) always takes place, and also can only take place, via a zone control unit (in zonal layer Z), and in particular also only via the zone control unit associated with the execution unit in question. In turn, a communication between two zone control units is possible solely or only takes place via computational layer R. The zone control units themselves are thus used only as a type of gateway or tunnel. Each zone control unit re-outputs incoming data with the content unchanged, or at best a formal adaptation to the other communication system, for example from LIN to Ethernet or from Ethernet to CAN, or encapsulation is carried out.

One example of a communication sequence would be that an intelligent mechatronic unit 132 associated with zone control unit 120A detects measured values via a sensor 134 associated with the intelligent mechatronic unit. These measured values are then tunneled as data by zone control unit 120A and transmitted to vehicle central computer 110. Vehicle central computer 110 may then process or convert these data (for example, make computations on the data). These processed data are then tunneled by zone control unit 120B, for example, and transmitted to control unit 130 associated with zone control unit 120B. This control unit 130 may, for example, activate an actuator associated with it according to instructions in the processed data, or may display the data on a display associated with it.

For example, if an application or software on control unit 130 associated with zone control unit 120B is to be updated, the software update, i.e., the new or updated program data, may initially be loaded onto vehicle central computer 110 via vehicle-remote processing unit 140. Vehicle central computer 110 may then in turn load the software update onto zone control unit 120B or transmit it there. From there, the software update may then in turn be loaded onto control unit 130 in order to update its software. Zone control unit 120B is thus used as a buffer for the software update.

In addition to software updates, which may also take place for zone control units as well as the vehicle central computer, also for individual applications there, for example a diagnosis or maintenance of the zone control units and their downstream execution units may take place by accessing them via the vehicle central computer and the explained communication.

As likewise mentioned above, the provided zone architecture also allows a simple scaling of the vehicle electrical system. Computing power or memory may be increased, for example in the computational layer, in particular in the vehicle central computer or optionally also via the vehicle-remote processing unit. New units may be supplemented on the execution layer relatively easily, in particular also using standard components such as sensors/actuators, and new zone control units may also be supplemented if necessary.

1-12. (canceled)

13. A method for operating a vehicle electrical system of a vehicle, the vehicle electrical system including a vehicle central computer, multiple intermediate control units, and multiple execution units, at least one of the multiple execution units being associated with each of the multiple intermediate control units, the vehicle electrical system being configured in an architecture in which the vehicle central computer is associated with a computational layer, the multiple intermediate control units are associated with an intermediate layer, and the multiple execution units are associated with an execution layer, the multiple intermediate control units each being communicatively connected to the vehicle central computer via a first communication system, and each execution unit of the multiple execution units being communicatively connected, directly or indirectly, to the intermediate control unit associated with the execution unit via a second communication system, the method comprising:
communicating between each execution unit of the multiple execution units and the vehicle central computer via the intermediate control unit associated with the execution unit; and
communicating between any two of the multiple intermediate control units solely via the computational layer.

14. The method as recited in claim 13, wherein in the communication between each execution unit of the execution units and the vehicle central computer via the intermediate control unit associated with the execution unit, the intermediate control unit associated with the execution unit re-outputs incoming data unchanged within the scope of the communication.

15. The method as recited in claim 13, wherein a service-based communication interface is provided from the vehicle central computer to the multiple intermediate control units.

16. The method as recited in claim 13, wherein an update of an application on one of the execution units takes place in that updated program data are loaded by the vehicle central computer onto the intermediate control unit associated with the execution unit, and then loading the updated program data by the intermediate control unit associated with the execution unit onto the execution unit.

17. The method as recited in claim 16, wherein the updated program data are initially loaded onto the vehicle central computer via a wireless communication link.

18. A vehicle electrical system for a vehicle, comprising:
a vehicle central computer;
multiple intermediate control units; and
multiple execution units, at least one of the multiple execution units being associated with each of the multiple intermediate control units;
wherein the vehicle electrical system is configured in an architecture in which the vehicle central computer is associated with a computational layer, the multiple intermediate control units are associated with an intermediate layer, and the multiple execution units are associated with an execution layer, the multiple intermediate control units each being communicatively connected to the vehicle central computer via a first communication system, and each execution unit of the multiple execution units being communicatively connected, directly or indirectly, to the intermediate control unit associated with the execution unit via a second communication system, the vehicle electrical system being configured in such a way that a communication between each execution unit of the execution units and the vehicle central computer takes place via the intermediate control unit associated with the execution unit, and a communication between any two of the multiple intermediate control units take place solely via the computational layer.

19. The vehicle electrical system as recited in claim 18, which is further configured in such a way that in the communication between each execution unit of the execution units and the vehicle central computer via the intermediate control unit associated with the execution unit, the intermediate control unit associated with the execution unit re-outputs incoming data unchanged within the scope of the communication.

20. The vehicle electrical system as recited in claim 18, which is configured to perform:
communicating between each execution unit of the multiple execution units and the vehicle central computer via the intermediate control unit associated with the execution unit; and
communicating between any two of the multiple intermediate control units solely via the computational layer

21. A control unit for use as an intermediate control unit in a vehicle electrical system for a vehicle, the vehicle electrical system including a vehicle central computer, multiple intermediate control units, and multiple execution units, at least one of the multiple execution units being associated with each of the multiple intermediate control units, the vehicle electrical system being configured in an architecture in which the vehicle central computer is associated with a computational layer, the multiple intermediate control units are associated with an intermediate layer, and the multiple execution units are associated with an execution layer, the multiple intermediate control units each being communicatively connected to the vehicle central computer via a first communication system, and each execution unit of the multiple execution units being communicatively connected, directly or indirectly, to the intermediate control unit associated with the execution unit via a second communication system, the control unit being configured in such a way that the control unit is associated with the intermediate layer when used in the vehicle electrical system, the control unit configured to enable a communication between each execution unit associated with the control unit and the vehicle central computer, and the control unit being configured to carry out a communication with some other intermediate control unit solely via the computational layer.

22. The control unit as recited in claim 21, which is further configured in such a way that in the communication between each of the execution units associated with the control unit and the vehicle central computer, the control unit re-outputs incoming data unchanged within the scope of the communication.

23. A method for configuring a vehicle electrical system in a vehicle, the vehicle electrical system including a vehicle central computer, multiple intermediate control units, and multiple execution units, at least one of the multiple execution units being associated with each of the multiple intermediate control units, the method comprising:
configuring the vehicle electrical system in an architecture in which the vehicle central computer is associated with a computational layer, the multiple intermediate control units are associated with an intermediate layer, and the multiple execution units are associated with an execution layer, the multiple intermediate control units each being communicatively connected to the vehicle central computer via a first communication system, and each execution unit of the multiple execution units being communicatively connected, directly or indirectly, to the intermediate control unit associated with the execution unit via a second communication system, the vehicle electrical system being configured in such a way that a communication between each execution unit of the multiple execution units and the vehicle central computer takes place via the intermediate control unit associated with the execution unit, and a communication between any two of the multiple intermediate control units takes place solely via the computational layer.

24. The method as recited in claim 23, wherein the vehicle electrical system is further configured in such a way that in the communication between each execution unit of the execution units and the vehicle central computer via the intermediate control unit associated with the execution unit, the intermediate control unit associated with the execution unit re- outputs incoming data unchanged within the scope of the communication.
